(19) United States
(12) Patent Application Publication
(10) Pub. No.: US 2008/0307035 A1
(43) Pub. Date: Dec. 11, 2008

(54) System and Method for Off-loading Online Meeting Updates Using Forward Proxy

(76) Inventors: Erik John Burckart, Raleigh, NC (US); John Paul Cammarata, Wake Forest, NC (US); Madhu K. Chetuparambil, Raleigh, NC (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 11/758,485

(22) Filed: Jun. 5, 2007

(51) Int. Cl. G06F 15/16

(52) U.S. Cl. 709/203

(57) ABSTRACT

A system and method for batching individual content requests received from clients at a forward proxy, and sending a batch content request from the forward proxy to a collaboration server is presented. A forward proxy sends an authorization request to the collaboration server for authorization. In turn, the collaboration server verifies each of the clients and provides the forward proxy with a personalized cookie for each client. Subsequently, the forward proxy receives individual content request from different clients for the same content. The forward proxy includes personalized attributes for each of the requesting clients, which include the personalized cookies, in a batched content request to the collaboration server. The collaboration server generates a batch content response, which includes the requested content, and sends the batch content response to the forward proxy. In turn, the forward proxy parses the batched content response and sends the requested content to clients that requested the content.

### BACKGROUND OF THE INVENTION

1. Technical Field

The present invention relates to a system and method for batching individual content requests that are received from clients at a forward proxy, and sending a batch content request from the forward proxy to a collaboration server.

2. Description of the Related Art

In today's distributed online meeting sessions, a speaker (publishing participant) typically controls a set of slides, which are managed at a collaboration server, while other participants view the slides from various access points. Participants from a corporation are usually located in “clusters” at a regional facility, such as in Raleigh, N.C. and Austin, Tex. Since each participant individually requests content updates from the collaboration server, a large degree of bandwidth is required between each of the participant's computers and the collaboration server. It would be desirable to have a mechanism to decrease bandwidth and processing requirements between participant access points and the collaboration server for these regional areas during online meeting sessions.

### SUMMARY

It has been discovered that the aforementioned challenges are resolved using a system and method for batching individual content requests received from clients at a forward proxy, and sending a batch content request from the forward proxy to a collaboration server. A forward proxy receives a first content request from a first client. In response to receiving the first content request, the forward proxy identifies a first set of personal attributes that correspond to the first client. Next, the forward proxy receives a second content request from a second client. Again, in response to receiving the second content request, the forward proxy identifies a second set of personal attributes that correspond to the second client. In turn, the forward proxy inserts the first set of personal attributes and the second set of personal attributes in a batch content request. The forward proxy then sends the batch content request to a downstream server.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a forward proxy receiving individual content requests and sending a batch content request to a collaboration server;

FIG. 2 is a diagram showing communication between clients, a forward proxy, and a collaboration server during an online meeting session;

FIG. 3 is a flowchart showing steps taken in a forward proxy authorizing clients with a collaboration server;

FIG. 4 is a flowchart showing steps taken in a forward proxy grouping individual client requests into a batch content request and sending the batch content request to a collaboration server;

FIG. 5 is a flowchart showing steps taken in a collaboration server processing a batch content request; and

FIG. 6 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

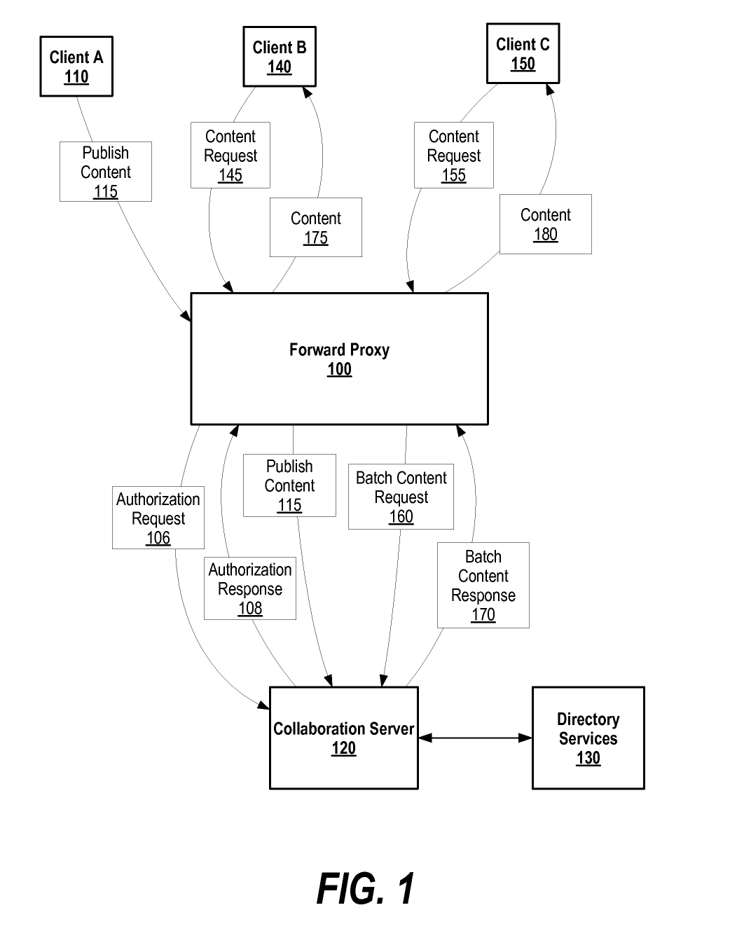

FIG. 1 is a diagram showing a forward proxy receiving individual content requests and sending a batch content request to a collaboration server. Forward proxy 100 batches content requests received from various clients (e.g., client B 140 and client C 150) and sends batched content request 160 to collaboration server 120. By batching the content requests, forward proxy 100 reduces bandwidth requirements between forward proxy 100 and collaboration server 120, along with alleviating collaboration server 120's processing requirements to process individual content requests.

In order to authorize client A 110, client B 140, and client C 150 for an online meeting, forward proxy 100 sends authorization request 106, which includes client credentials for participating clients, to collaboration server 120. Collaboration server 120 communicates with directory services 130 to verify client authorization, and sends authorization response 108 to forward proxy 100. Authorization response 108 includes a personalized cookie for each authorized client, along with session information that identifies the particular online meeting session. In turn, forward proxy 100 sends the personalized cookies and session information to clients A 110, B 140, and C 150.

Once authorized, client A 110 sends publish content 115 to forward proxy 100. Publish content 115 is a request to publish or change particular content (e.g., slides) that clients use during an online meeting session. Forward proxy 100 receives publish content 115 and forwards it to collaboration server 120. Collaboration server 120 receives publish content 115, and stores the content for subsequent client distribution.

Forward proxy 100 receives content request 145 from client B 140, which is a request for new/updated content corresponding to the online meeting. Forward proxy 100 logs the content request and waits for similar requests from other clients for a particular amount of time based upon a batch timer. Before the batch timer expires, client C 150 sends content request 155 to forward proxy 100, which requests the same content as requested by client B 140. Since client B 140 and client C 150 are requesting the same content, forward proxy 100 includes their personalized attributes into batch content request 160, and sends batch content request 160 to collaboration server 120.

Collaboration server 120 parses batch content request 160 and verifies that each of the clients is authorized. Next, collaboration server 120 retrieves the requested content and sends batch content response 170 to forward proxy 100. Batch content response 170 includes the requested content, along with session information that informs forward proxy 100 as to which client to send the requested content. Forward proxy 100 parses batch content response 170, and individually sends content 175 and content 180 to client B 140 and client C 150, respectively.

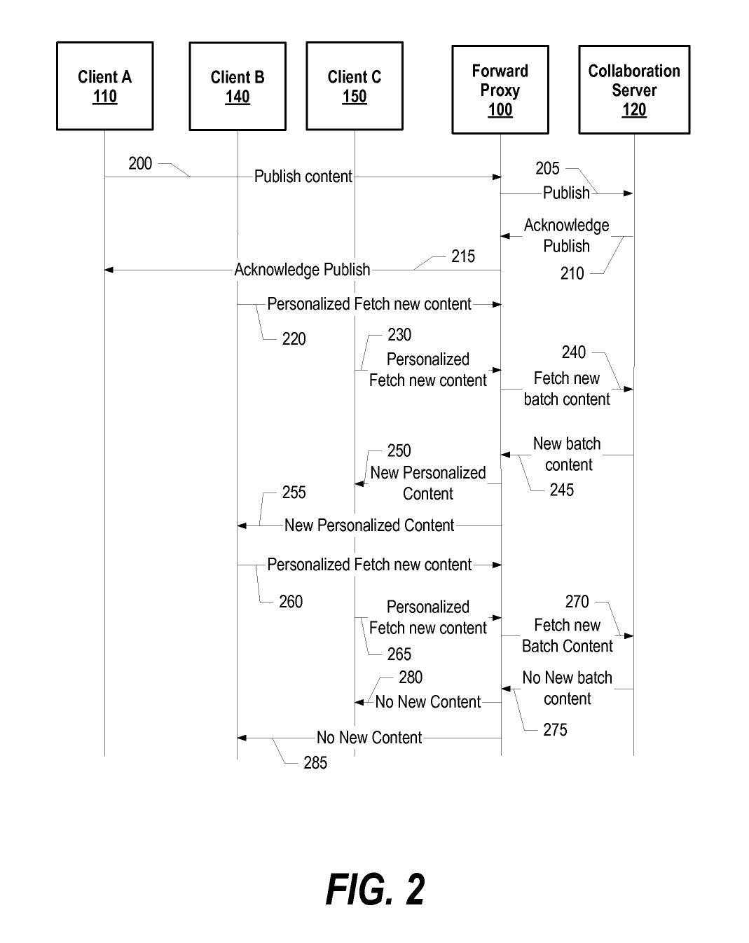

FIG. 2 is a diagram showing communication between clients, a forward proxy, and a collaboration server during an online meeting session. Client A 110 sends publish content 200 to forward proxy 100 to publish content for an online meeting. In turn, forward proxy 100 sends publish content 205 to collaboration server 120. Collaboration server 120 stores the content, and sends acknowledge publish 210 to forward proxy 100. Forward proxy sends acknowledge publish 215 to client A 110. At this point, collaboration server 120 is able to provide client A 110's published content (new and/or modified) to participating clients. Client A 110, forward proxy 100, and collaboration server 120 are the same as that shown in FIG. 1.

At particular intervals, client B 140 sends new content request 220 to forward proxy 100. At independent intervals, client C 150 sends new content request 230 to forward proxy 100. Forward proxy 100 generates a batch content request, which includes client B 140's personalized attributes and client C 150's personalized attributes, into a batch content request and sends batch content request 240 to collaboration server 120. Collaboration server 120 composes a batch content response, which includes the requested content and session information, and sends batch content response 245 to forward proxy 100. Forward proxy parses the batch content response and sends new personalized content 250 to client C 150 and new personalized content 255 to client B 140. Client B 140 and client C 150 are the same as that shown in FIG. 1.

At subsequent intervals, client B 140 and client C 150 send content request 260 and content request 265, respectively, to forward proxy 100. Forward proxy 100 batches the content requests together, and sends batch content request 270 to collaboration server 120. Collaboration server 120 determines that no new content is available for the corresponding online session, and sends no new batch content 275 to forward proxy 100. In turn, forward proxy 100 informs client C 150 and client B 140 that no new content is available via no new content messages 280 and 285, respectively.

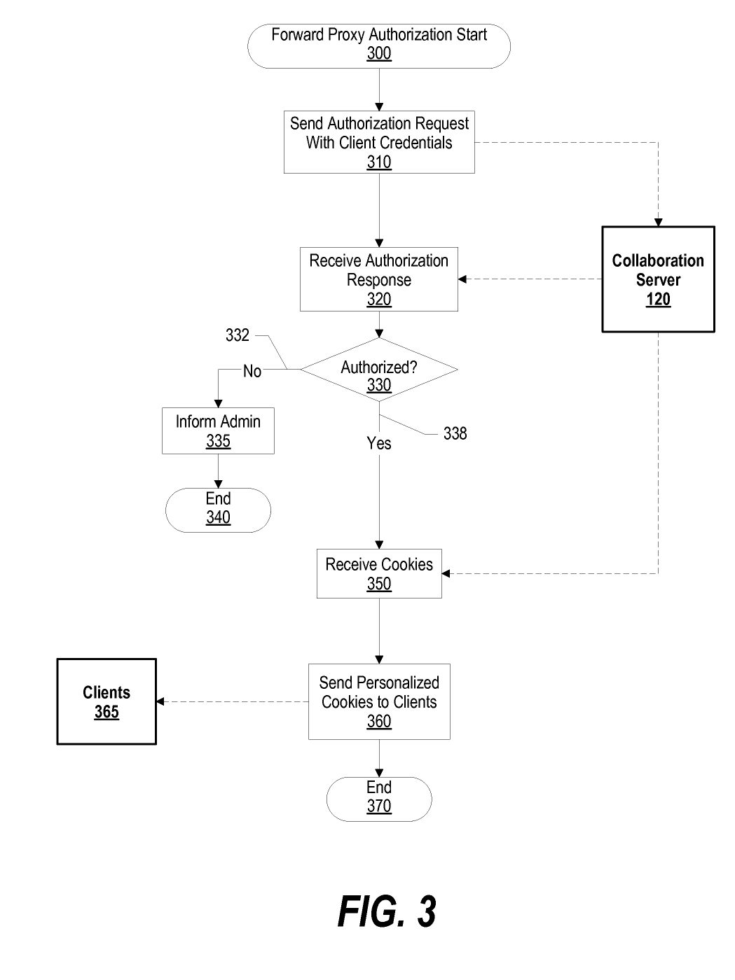

FIG. 3 is a flowchart showing steps taken in a forward proxy authorizing clients with a collaboration server. A forward proxy sends client credentials to a collaboration server in order to guarantee the client is authorized for a particular online meeting. In turn, the collaboration server sends a personalized cookie for the client that the forward proxy uses for subsequent batch requests.

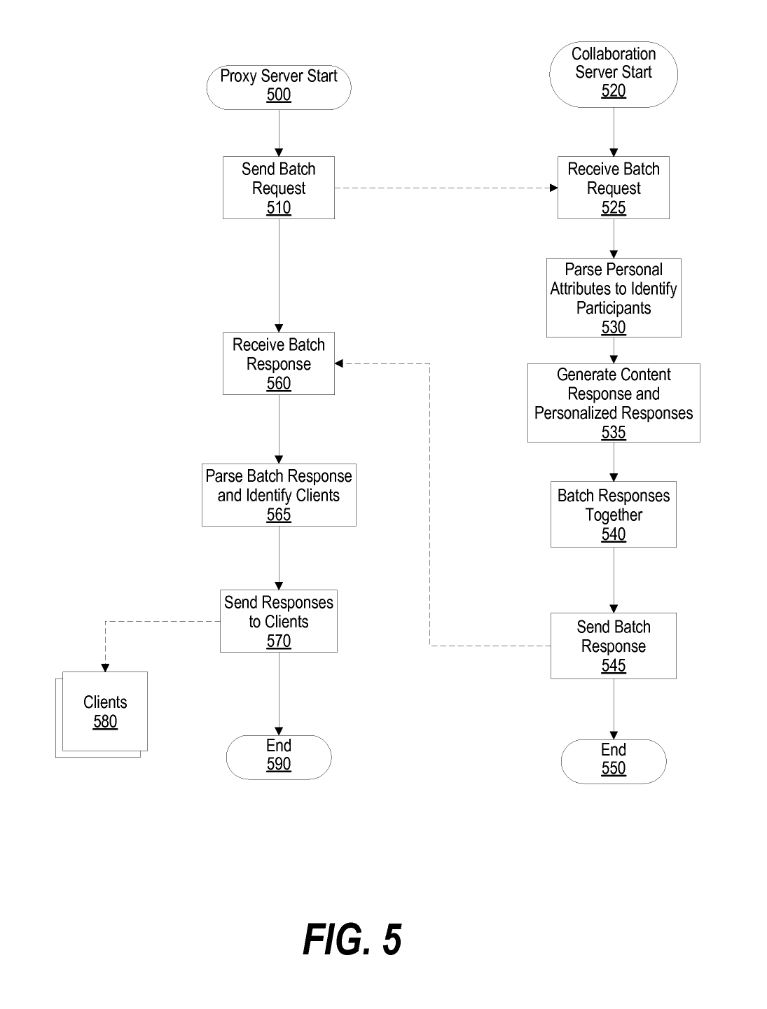

Processing commences at 300, whereupon the forward proxy sends an authorization request to collaboration server 120 that includes client credentials. Collaboration server 120 determines whether to authorize each of the clients, and sends an authorization response, which the forward proxy receives at step 320 (see FIG. 5 and corresponding text for further details).

A determination is made as to whether collaboration server 120 authorized the clients (decision 330). If collaboration server 120 did not authorize the clients, decision 330 branches to “No ” branch 332 whereupon processing informs an administrator at step 335, and processing ends at 340.

On the other hand, if collaboration server 120 authorized the clients, decision 330 branches to “Yes” branch 338 whereupon processing receives a personalized cookie for each of the clients from collaboration server 120 (step 350). The forward proxy then sends the personalized cookies to clients 365 at step 360, and processing ends at 370.

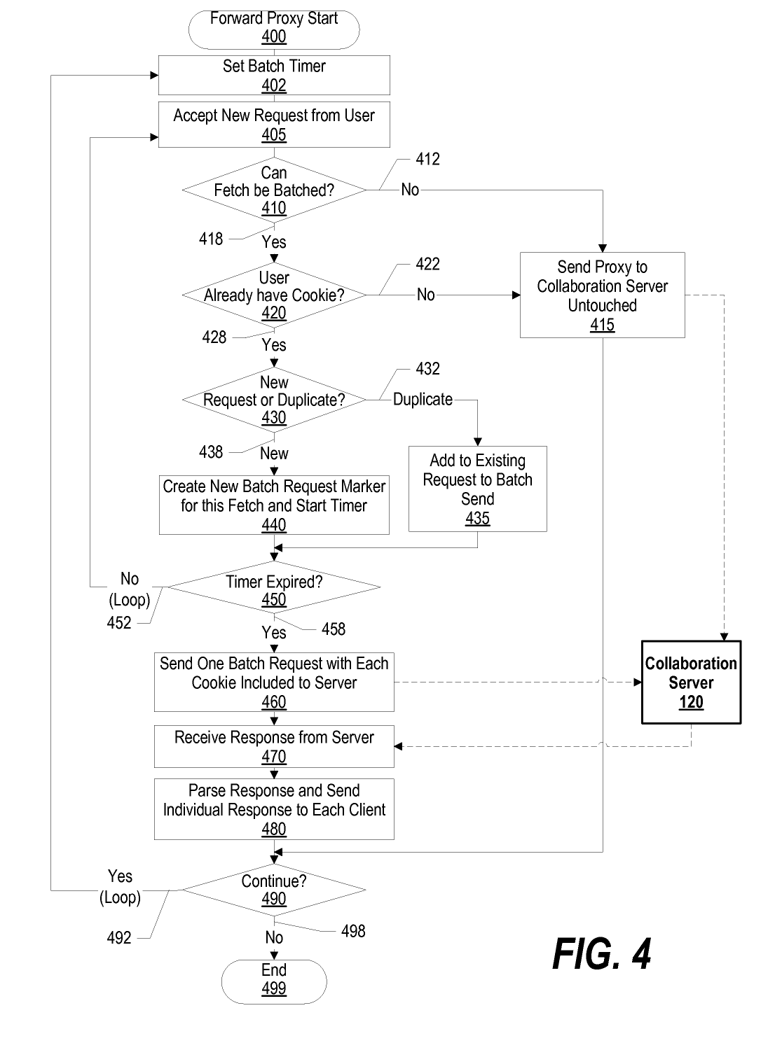

FIG. 4 is a flowchart showing steps taken in a forward proxy grouping individual client requests into a batch content request and sending the batch content request to a collaboration server.

Processing commences at 400, whereupon processing sets a batch timer at step 402. The batch timer informs the forward proxy times at which to send a batch content request, such as every 10 seconds. At step 405, the forward proxy accepts a new content request from a client at step 405. A determination is made as to whether the requested content may be batched (decision 410). For example, hatchable content may be non-personalized content, such as a slide, a document for review, or weather for a specific city. Non-batchable content may be personalized information or an action performed, such as posting a new slide for review, document edits sent to a server, or stock portfolio quotes. If the requested content cannot be batched, decision 410 branches to “No” branch 412 whereupon the forward proxy sends the content request to collaboration server 120 at step 415.

On the other hand, if the requested content can be batched, decision 410 branches to “Yes” branch 418 whereupon a determination is made as to whether the requesting client has a personalized cookie (decision 420). The forward proxy requires the client to have a registered personalized cookie in order for the forward proxy to be able to batch the content request with other client requests. If the client does not have a registered personalized cookie, decision 420 branches to “No” branch 422 whereupon the forward proxy sends a content request to collaboration server 120 at step 415.

On the other hand, if the client has a personalized cookie, decision 420 branches to “Yes” branch 428 whereupon a determination is made as to whether the content request is the first request for the particular content. For example, the forward proxy may have recently received a content request from another client that is requesting the same content. If the content request is a duplication of a recent content request, decision 430 branches to “Duplicate” branch 432 whereupon processing adds the requesting client's personalized attributes to the batch content request at step 435. The personalized attributes include the client's personalized cookie and other personalized request parameters such as a user ID, an IP Address, and may also include actions such as raising your hand in an online meeting or marking a user's status to “do not disturb” in the meeting.

On the other hand, of the content request is a new request, decision 430 branches to “New” branch 438 whereupon the forward proxy starts the batch timer and creates a new batch request, which includes a content request and the client's personalized attributes.

A determination is made as to whether the batch timer has expired (decision 450). If the batch timer has not expired, decision 450 branches to “No” branch 452, which loops back to process more client requests. This looping continues until the batch timer has expired, at which point decision 450 branches to “Yes” branch 458 whereupon the forward proxy sends a batch content request to collaboration server 120, which includes personalized attributes of each client requesting the particular content (step 460).

Collaboration server 120 receives and processes the patch content request (see FIG. 5 and corresponding text for further details). At step 470, the forward proxy receives a batch content response from collaboration server 120. The batch content response includes the requested content as well as session information that allows the forward proxy to identify which clients should receive the requested content.

The forward proxy parses the batch content response in order to extract the session information and individually sends the content to each of the clients corresponding to the session information (step 480). A determination is made as to whether to continue processing (decision 490). If processing should continue, decision 490 branches to “Yes” branch 492, which loops back to process more client requests. This looping continues until processing should terminate, at which point decision 490 branches to “No” branch 498 whereupon processing ends at 499.

FIG. 5 is a flowchart showing steps taken in a collaboration server processing a batch content request. Forward proxy processing commences at 500, whereupon the forward proxy sends a batch content request to a collaboration server. The batch content request includes personalized attributes for multiple clients that are requesting a content update corresponding to the same meeting.

Collaboration server processing commences at 520, whereupon the collaboration server receives the batch content request at step 525. At step 530, the collaboration server parses the personal attributes included in the batch content request in order to identify the meeting participants. In one embodiment, the collaboration server verifies that the participants are authorized to participate in the online meeting.

Processing generates a content response, which may include slide updates for the online meeting, along with personalized responses (step 535). Personalized responses may be in the form of setting the proper cookie for the user or encoding the content in a way that the user's browser can interpret, such as using compression or a lower resolution. The collaboration server then batches the personalized responses together with the content response (step 540), and sends a batch content response to the proxy server at step 545. Collaboration server processing ends at 550.

The forward proxy receives the batch content response at step 560, and parses the batch content response in order to identify client recipients (step 565). Once identified, the forward proxy server sends the content response to each of clients 580 at step 570, and processing ends at 590.

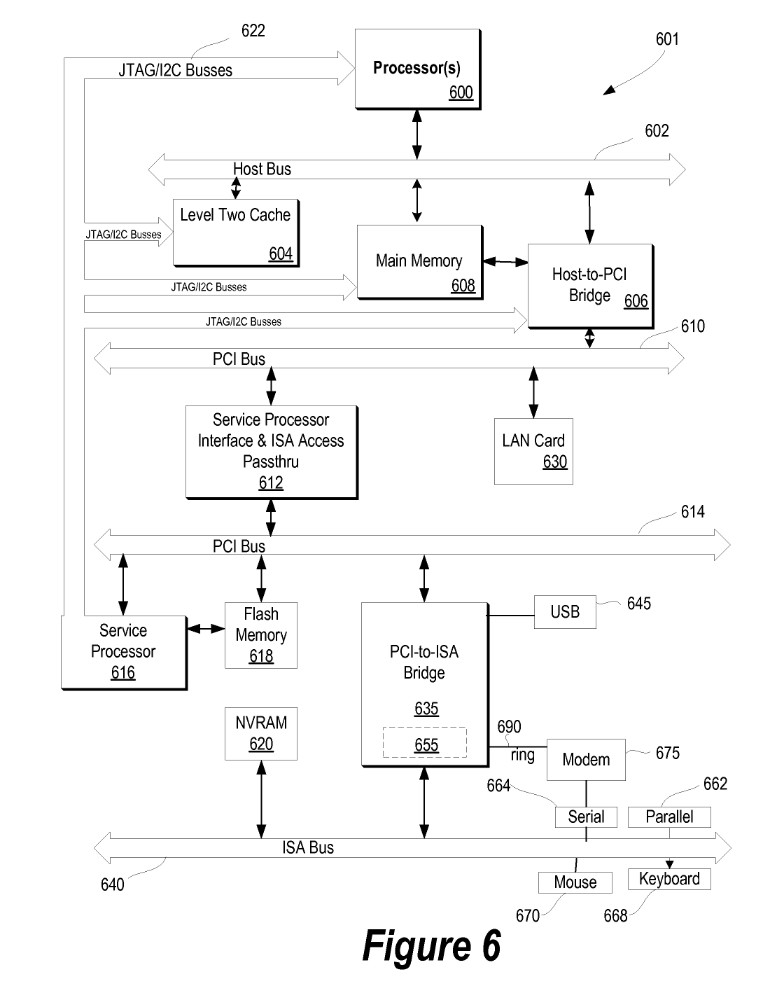

FIG. 6 illustrates information handling system 601 which is a simplified example of a computer system capable of performing the computing operations described herein. Computer system 601 includes processor 600 which is coupled to host bus 602. A level two (L2) cache memory 604 is also coupled to host bus 602. Host-to-PCI bridge 606 is coupled to main memory 608, includes cache memory and main memory control functions, and provides bus control to handle transfers among PCI bus 610, processor 600, L2 cache 604, main memory 608, and host bus 602. Main memory 608 is coupled to Host-to-PCI bridge 606 as well as host bus 602. Devices used solely by host processor(s) 600, such as LAN card 630, are coupled to PCI bus 610. Service Processor Interface and ISA Access Pass-through 612 provides an interface between PCI bus 610 and PCI bus 614. In this manner, PCI bus 614 is insulated from PCI bus 610. Devices, such as flash memory 618, are coupled to PCI bus 614. In one implementation, flash memory 618 includes BIOS code that incorporates the necessary processor executable code for a variety of low-level system functions and system boot functions.

PCI bus 614 provides an interface for a variety of devices that are shared by host processor(s) 600 and Service Processor 616 including, for example, flash memory 618. PCI-to-ISA bridge 635 provides bus control to handle transfers between PCI bus 614 and ISA bus 640, universal serial bus (USB) functionality 645, power management functionality 655, and can include other functional elements not shown, such as a real-time clock (RTC), DMA control, interrupt support, and system management bus support. Nonvolatile RAM 620 is attached to ISA Bus 640. Service Processor 616 includes JTAG and I2C busses 622 for communication with processor(s) 600 during initialization steps. JTAG/I2C busses 622 are also coupled to L2 cache 604, Host-to-PCI bridge 606, and main memory 608 providing a communications path between the processor, the Service Processor, the L2 cache, the Host-to-PCI bridge, and the main memory. Service Processor 616 also has access to system power resources for powering down information handling device 601.

Peripheral devices and input/output (I/O) devices can be attached to various interfaces (e.g., parallel interface 662, serial interface 664, keyboard interface 668, and mouse interface 670 coupled to ISA bus 640. Alternatively, many I/O devices can be accommodated by a super I/O controller (not shown) attached to ISA bus 640.

In order to attach computer system 601 to another computer system to copy files over a network, LAN card 630 is coupled to PCI bus 610. Similarly, to connect computer system 601 to an ISP to connect to the Internet using a telephone line connection, modem 665 is connected to serial port 664 and PCI-to-ISA Bridge 635.

While FIG. 6 shows one information handling system that employs processor(s) 600, the information handling system may take many forms. For example, information handling system 601 may take the form of a desktop, server, portable, laptop, notebook, or other form factor computer or data processing system. Information handling system 601 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a first content request at a forward proxy from a first client;
in response to receiving the first content request, identifying first personal attributes corresponding to the first client;
receiving a second content request at the forward proxy from a second client;
in response to receiving the second content request, identifying second personal attributes corresponding to the second client;
inserting the first personal attributes and the second personal attributes into a batch content request; and
sending the batch content request to a downstream server.

2. The method of claim 1 further comprising:
receiving the batch content request at the downstream server;
processing the batch content request at the downstream server, which comprises extracting the first personal attributes and the second personal attributes;
retrieving content data corresponding to the batch content request;
inserting the content data into a batch content response; and
sending the batch content response to the forward proxy.

3. The method of claim 2 further comprising:
receiving the batch content response at the forward proxy;
parsing the batch content response, which comprises extracting the content data; and
sending the content data to the first client and the second client.

4. The method of claim 2 wherein the processing further comprises:
authorizing, at the downstream server, the first client using the first personalized attributes; and
authorizing, at the downstream server, the second client using the second personalized attributes.

5. The method of claim 1 wherein the first personalized attributes comprise a first personalized cookie and a first update request, and the second personalized attributes comprise a second personalized cookie and a second update request, the method further comprising:
determining that the first update request and the second update request are requesting the content data;
in response to determining that the first update request and the second update request are requesting the content data, inserting the first personalized cookie, the first update request, the second personalized cookie, and the second update request into the batch content request.

6. The method of claim 5 wherein, prior to receiving the first content request and the second content request, the method further comprises:
receiving a first authorization request at the downstream server from the proxy server to authorize the first client;
in response to determining that the first client is authorized, sending the first personalized cookie from the downstream server to the forward proxy;
forwarding the first personalized cookie from the forward proxy to the first client;
receiving a second authorization request at the downstream server from the proxy server to authorize the second client;
in response to determining that the second client is authorized, sending the second personalized cookie from the downstream server to the forward proxy; and
forwarding the second personalized cookie from the forward proxy to the second client.

7. The method of claim 1 further comprising:
receiving a request from a publishing client at the forward proxy to publish content data;
sending a publish request from the forward proxy to the downstream server to publish the content data;
receiving the publish request at the downstream server; and
in response to receiving the publish request at the downstream server, publishing the content data.

8. A computer program product stored on a computer operable media, the computer operable media containing instructions for execution by a computer, which, when executed by the computer, cause the computer to implement a method of batching individual content requests, the method comprising:
receiving a first content request at a forward proxy from a first client;
in response to receiving the first content request, identifying first personal attributes corresponding to the first client;
receiving a second content request at the forward proxy from a second client;
in response to receiving the second content request, identifying second personal attributes corresponding to the second client;
inserting the first personal attributes and the second personal attributes into a batch content request; and
sending the batch content request to a downstream server.

9. The computer program product of claim 8 wherein the method further comprises:
receiving the batch content request at the downstream server;
processing the batch content request at the downstream server, which comprises extracting the first personal attributes and the second personal attributes;
retrieving content data corresponding to the batch content request;
inserting the content data into a batch content response; and
sending the batch content response to the forward proxy.

10. The computer program product of claim 9 wherein the method further comprises:
receiving the batch content response at the forward proxy;
parsing the batch content response, which comprises extracting the content data; and
sending the content data to the first client and the second client.

11. The computer program product of claim 9 wherein the method further comprises:
authorizing, at the downstream server, the first client using the first personalized attributes; and
authorizing, at the downstream server, the second client using the second personalized attributes.

12. The computer program product of claim 8 wherein the first personalized attributes comprise a first personalized cookie and a first update request, and the second personalized attributes comprise a second personalized cookie and a second update request, the method further comprising:
determining that the first update request and the second update request are requesting the content data;
in response to determining that the first update request and the second update request are requesting the content data, inserting the first personalized cookie, the first update request, the second personalized cookie, and the second update request into the batch content request.

13. The computer program product of claim 12 wherein, prior to receiving the first content request and the second content request, the method further comprises:
receiving a first authorization request at the downstream server from the proxy server to authorize the first client;
in response to determining that the first client is authorized, sending the first personalized cookie from the downstream server to the forward proxy;
forwarding the first personalized cookie from the forward proxy to the first client;
receiving a second authorization request at the downstream server from the proxy server to authorize the second client; in response to determining that the second client is authorized, sending the second personalized cookie from the downstream server to the forward proxy; and
forwarding the second personalized cookie from the forward proxy to the second client.

14. The computer program product of claim 8 wherein the method further comprises:
receiving a request from a publishing client at the forward proxy to publish content data;
sending a publish request from the forward proxy to the downstream server to publish the content data;
receiving the publish request at the downstream server; and
in response to receiving the publish request at the downstream server, publishing the content data.

15. An information handling system comprising:
one or more processors;
a memory accessible by the processors;
one or more nonvolatile storage devices accessible by the processors; and
a set of instructions stored in the memory at a forward proxy, wherein one or more of the processors executes the set of instructions in order to perform actions of:
receiving a first content request at the forward proxy from a first client;
in response to receiving the first content request, identifying first personal attributes corresponding to the first client;
receiving a second content request at the forward proxy from a second client;
in response to receiving the second content request, identifying second personal attributes corresponding to the second client;
inserting the first personal attributes and the second personal attributes into a batch content request; and
sending the batch content request to a downstream server.

16. The information handling system of claim 15 further comprising an additional set of instructions in order to perform actions of:
receiving the batch content request at the downstream server;
processing the batch content request at the downstream server, which comprises extracting the first personal attributes and the second personal attributes;
retrieving content data corresponding to the batch content request;
inserting the content data into a batch content response; and
sending the batch content response to the forward proxy.

17. The information handling system of claim 16 further comprising an additional set of instructions in order to perform actions of:
receiving the batch content response at the forward proxy;
parsing the batch content response, which comprises extracting the content data; and
sending the content data to the first client and the second client.

18. The information handling system of claim 16 further comprising an additional set of instructions in order to perform actions of:
authorizing, at the downstream server, the first client using the first personalized attributes; and
authorizing, at the downstream server, the second client using the second personalized attributes.

19. The information handling system of claim 15 wherein the first personalized attributes comprise a first personalized cookie and a first update request, and the second personalized attributes comprise a second personalized cookie and a second update request, the information handling system further comprising an additional set of instructions in order to perform actions of:
determining that the first update request and the second update request are requesting the content data;
in response to determining that the first update request and the second update request are requesting the content data, inserting the first personalized cookie, the first update request, the second personalized cookie, and the second update request into the batch content request.

20. The information handling system of claim 19 wherein, prior to receiving the first content request and the second content request, the information handling system further comprising an additional set of instructions in order to perform actions of:
receiving a first authorization request at the downstream server from the proxy server to authorize the first client;
in response to determining that the first client is authorized, sending the first personalized cookie from the downstream server to the forward proxy;
forwarding the first personalized cookie from the forward proxy to the first client;
receiving a second authorization request at the downstream server from the proxy server to authorize the second client;
in response to determining that the second client is authorized, sending the second personalized cookie from the downstream server to the forward proxy; and
forwarding the second personalized cookie from the forward proxy to the second client.
